(19) United States
(12) Patent Application Publication
(10) Pub. No.: US 2018/0046891 A1
(43) Pub. Date: Feb. 15, 2018

(54) NFC TAG HAVING DUAL MODE

(71) Applicant: Je Young JUNG, Seoul (KR)

(72) Inventor: Je Young JUNG, Seoul (KR)

(21) Appl. No.: 15/554,951

(22) PCT Filed: Mar. 2, 2016
(86) PCT No.: PCT/KR2016/002072

§ 371 Date: Aug. 31, 2017

(30) Foreign Application Priority Data
Mar. 2, 2015 (KR) 10-2015-0028778

(51) Int. Cl. G06K 19/07

(52) U.S. Cl. CPC G06K 19/0724; G06K 19/0727

(57) ABSTRACT

According to at least one embodiment of the present invention, disclosed is an NFC tag having a dual mode, the NFC tag comprising a first NFC chip which can perform a first operation; and a second NFC chip which can perform a second operation, wherein the second NFC chip reaches a state of being able to perform the second operation in the case where the NFC tag having a dual mode is not supplied with power from the outside or in the case where trouble occurs in equipment in which the NFC tag having a dual mode is mounted.

### TECHNICAL FIELD

The present invention relates to a near field communication (NFC) tag having a dual mode.

### BACKGROUND ART

Near Field Communication (NFC) is contactless short-range wireless communication that uses a frequency band of 13.56 MHz and a technology for bidirectionally transmitting data between terminals over a short distance of 10 cm or less. NFC is widely used for payment, product information at supermarkets or general stores, travel information transmission for visitors, transportation, access control locking devices, communication between devices, and the like.

### DISCLOSURE

### Technical Problem

Therefore, the present invention has been made in view of the above problems, and it is one object of the present invention to provide an NFC tag having a dual mode.

It is another object of the present invention to provide a device including the NFC tag having a dual mode.

### Technical Solution

In accordance with one aspect of the present invention, provided is

an NFC tag having a dual mode, including:

a first NFC chip capable of performing a first operation; and

a second NFC chip capable of performing a second operation,

wherein the second NFC chip is in a state capable of performing the second operation in a case in which the NFC tag having a dual mode is unable to be supplied with power from the outside or malfunction occurs in equipment equipped with the NFC tag having a dual mode.

In accordance with another aspect of the present invention, provided is

an NFC tag having a dual mode including

an NFC chip capable of performing a first operation or a second operation,

wherein the NFC chip is in a state capable of performing the second operation in a case in which the NFC tag having a dual mode is unable to be supplied with power from the outside or malfunction occurs in equipment equipped with the NFC tag having a dual mode.

In accordance with another aspect of the present invention, provided is

a method of operating an NFC tag having a dual mode, the method including:

confirming whether or not power is supplied to the NFC tag having a dual mode or malfunction occurs in equipment equipped with the NFC tag having a dual mode;

maintaining a state of the NFC tag having a dual mode being supplied with power and capable of performing a normal operation; and

maintaining a state capable of performing a second operation in a case in which power is not supplied to the NFC tag having a dual mode or malfunction occurs in the equipment equipped with the NFC tag having a dual mode.

In the above-described embodiments, the second operation may be an operation of transmitting a telephone number or a contact address to a reader of the NFC tag.

### Advantageous Effects

According to one or more embodiments of the present invention, a plurality of functions (operations) can be performed using a single NFC tag.

### DESCRIPTION OF DRAWINGS

FIG. 1 illustrates views for explaining an NFC tag having a dual mode according to an embodiment of the present invention.

FIG. 2 is a view for explaining an NFC tag having a dual mode according to another embodiment of the present invention.

FIG. 3 is a diagram for explaining a method of operating an NFC tag having a dual mode, according to an embodiment of the present invention.

FIG. 4 is a diagram for explaining a method of operating an NFC tag having a dual mode, according to another embodiment of the present invention.

### DESCRIPTION OF REFERENCE NUMERALS

1, 3, 12: NFC chips

7, 17: antennas

### BEST MODE

The above-described objects, other objects, characteristics, and advantages of the present invention will be readily apparent from the accompanying drawings and the related following exemplary embodiments. However, the present invention is not limited to the embodiments set forth herein and may be embodied in many different forms. Rather, these embodiments are provided so that this disclosure will be thorough and complete, and will fully convey the scope of the invention to those skilled in the art. In the present specification, when an element is referred to as being “on” another element, it can be directly on the other element or a third element may also be disposed between the elements. Meanwhile, terms such as “˜unit,” “˜portion,” “˜module,” and the like as used herein refer to a unit that processes at least one function or operation and may be implemented as hardware, software, or a combination thereof.

The terms used in the present specification are provided only for illustrative purposes and are not intended to limit the scope of the present invention. As used herein, the singular forms are intended to include the plural forms as well unless otherwise specifically mentioned in the context. The terms “comprises” and/or “comprising” as used herein do not preclude the presence or addition of one or more other elements, in addition to the aforementioned elements.

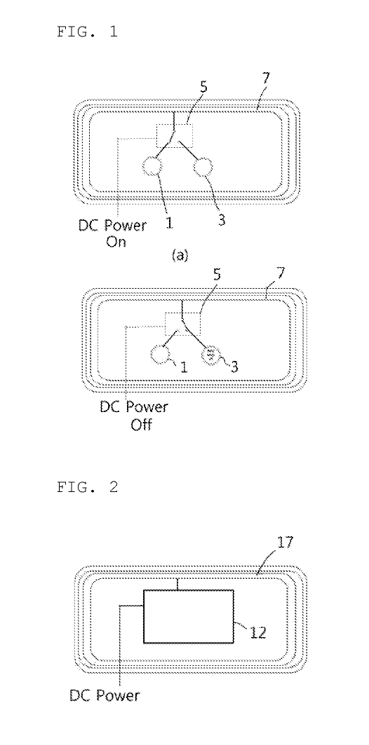

FIG. 1 illustrates views for explaining a near field communication (NFC) tag having a dual mode according to an embodiment of the present invention.

Referring to FIG. 1, the NFC tag having a dual mode according to an embodiment of the present invention is used for short-range wireless communication and has two types of operation modes. Meanwhile, the term ‘dual mode’ as used herein refers to a state capable of performing two operations, and a first operation, which is a normal operation, refers to an operation related to operation of a device equipped with an NFC tag.

The NFC tag having a dual mode according to an embodiment of the present invention is installed at a mobile device to support short-range wireless communication that enables bidirectional communication using a specific frequency. In this regard, the specific frequency may be, for example, 13.56 MHz, but this is provided for illustrative purposes only, and other frequencies may also be used.

Referring to FIG. 1, the NFC tag having a dual mode according to an embodiment of the present invention may include NFC chips 1 and 3 to transmit and receive NFC and the related data and control other applications (computer programs) and hardware, an antenna 7 to transmit and receive a radio frequency (RF) of a specific frequency, and an electronic relay (switch) 5. Although not shown in the drawing, the NFC tag may further include a security module for payment or customer information management.

Referring to FIG. 1, the NFC tag having a dual mode according to an embodiment of the present invention includes the NFC chips 1 and 3. For example, the NFC tag having a dual mode according to an embodiment of the present invention may include a first NFC chip 1 and a second NFC chip 3.

In a case in which a power is supplied to the NFC tag having a dual mode according to an embodiment of the present invention and a device equipped with the NFC tag normally operates without malfunction, the electronic relay 5 is switched so that the supplied power is supplied to the first NFC chip 1 (see FIG. 1(a)), and, in a case in which the supply of power is stopped or a device equipped with the NFC tag malfunctions, the electronic relay 5 is switched so that the second NFC chip 3 and the antenna 7 are functionally connected to each other (see FIG. 1(b)). That is, the electronic relay 5 performs an operation of switching to a state in which the first NFC chip 1 is operable or a state in which the second NFC chip 3 is operable.

In the present specification, no supply of power to the NFC tag having a dual mode according to an embodiment of the present invention from the outside means no supply of power thereto from equipment equipped with the NFC tag having a dual mode according to an embodiment of the present invention.

In the NFC tag having a dual mode according to an embodiment of the present invention, in a power supply state, the first NFC chip 1 and the antenna 7 are functionally connected to each other, and the first NFC chip 1 is in a state capable of performing an operation (an operation assigned to the first NFC chip 1) of the first NFC chip 1 via the antenna 7 (see FIG. 1(a)). In such a state, an NFC reader may read data stored in the first NFC chip 1 or perform an operation of recording data in the first NFC chip 1, via the antenna 7. Meanwhile, in the NFC tag having a dual mode according to an embodiment of the present invention, when power cannot be supplied or equipment equipped with the NFC tag malfunctions, the second NFC chip 3 and the antenna 7 are functionally connected to each other, and the second NFC chip 3 is in a state capable of performing an operation (an operation assigned to the second NFC chip 3) of the second NFC chip 3 via the antenna 7 (see FIG. 1(b)). In such a state, an NFC reader may read data stored in the second NFC chip 5 or perform an operation of recording data in the second NFC chip 5, via the antenna 7.

For example, it is assumed that the NFC tag having a dual mode according to an embodiment of the present invention is installed at a printer, the first NFC chip 1 performs an operation (a first operation) of printing images received via the antenna 7, and the second NFC chip 3 performs an operation of transmitting contact addresses stored therein or IDs representing contact addresses to a tag reader.

At this time, in a case (normal case) in which power is supplied to the NFC tag having a dual mode according to an embodiment of the present invention and equipment equipped with the NFC tag does not malfunction, the NFC tag is in a state in which an operation by the first NFC chip 1 can be performed (‘first operation mode’). In the first operation mode, when a smartphone equipped with an NFC reader is close to a tag, images stored in the smartphone are transmitted to the first NFC chip 1 via the antenna 7. Subsequently, the printer may print the images received by the first NFC chip 1.

Meanwhile, when power is not supplied to the NFC tag having a dual mode according to an embodiment of the present invention, the NFC tag is in a state in which an operation by the second NFC chip 3 can be performed (‘second operation mode’). In the second operation mode, when the smartphone equipped with an NFC reader is close to the tag, telephone numbers or IDs representing contact addresses stored in the second NFC chip 3 may be transmitted to the reader.

Subsequently, the smartphone provided with an NFC reader installed therein makes a call using the telephone number or ID transmitted from the NFC tag (e.g., the telephone number stored in the second NFC chip 3 may be an after service (A/S) center of a manufacturer that manufactures the printer). At this time, when the smartphone provided with an NFC reader installed therein makes a call, information (e.g., information about the printer, remote server information, or the like) stored in the second NFC chip 3 may be transmitted to a predetermined position (e.g., a server of the A/S center).

In the present embodiment, an example of applying the NFC tag having a dual mode according to an embodiment of the present invention to a printer has been described, but this is provided for illustrative purposes only, and the NFC tag having a dual mode according to an embodiment of the present invention may also be applied to other apparatuses (e.g., an electric rice cooker, a refrigerator, and the like).

In addition, in the present embodiment, the cases in which the first NFC chip 1 performs an operation of printing images, and the second NFC chip 3 performs a calling operation have been described, but this is provided for illustrative purposes only, and the NFC tag having a dual mode according to an embodiment of the present invention may also be applied to cases in which these chips perform other operations. In a case in which the NFC tag having a dual mode according to an embodiment of the present invention is applied to an electric rice cooker, the first NFC chip may perform an operation of making rice, and the second NFC chip may perform an operation of making a call to an A/S center of the electric rice cooker.

According to one embodiment, in a case in which equipment (e.g., a printer, an electric rice cooker, a refrigerator, and the like) equipped with the NFC tag having a dual mode according to an embodiment of the present invention cannot be provided with power, power is also not supplied to the NFC tag.

According to another embodiment, when equipment (e.g., a printer, an electric rice cooker, a refrigerator, and the like) equipped with the NFC tag having a dual mode according to an embodiment of the present invention malfunctions, supply of power to the NFC tag is stopped.

In the above embodiments, although the case in which, when the supply of power to the NFC tag having a dual mode according to an embodiment of the present invention is stopped, the second NFC chip 3 operates has been described, the present invention may be embodied in many different manners. For example, in a case in which equipment (e.g., a printer, an electric rice cooker, a refrigerator, and the like) equipped with the NFC tag having a dual mode according to an embodiment of the present invention malfunctions, a signal indicating occurrence of malfunction (“malfunction occurrence signal”) is transmitted to the NFC tag. When the NFC tag receives the malfunction occurrence signal, the NFC tag may be in a state in which the operation by the second NFC chip 3 can be performed.

FIG. 2 is a view for explaining an NFC tag having a dual mode according to another embodiment of the present invention.

Referring to FIG. 2, the NFC tag having a dual mode according to another embodiment of the present invention includes an NFC chip 12 to perform a first operation when power is supplied and to perform a second operation when power is not supplied or equipment equipped with the NFC tag malfunctions, and an antenna 17.

There is a difference between the embodiment described with reference to FIG. 1 and the embodiment described with reference to FIG. 2 in that the embodiment of FIG. 2 provides a single NFC chip capable of performing two operations. That is, referring to FIG. 2, the NFC tag having a dual mode according to another embodiment of the present invention includes the NFC chip 12 capable of performing at least two operations and the antenna 17.

The NFC chip 12 may perform at least first and second operation modes. For example, the NFC chip 12 performs the first operation mode in the case of being supplied with power from equipment equipped with the NFC tag and performs the second operation mode in the case of being unable to be supplied with power. In another embodiment, the NFC chip 12 performs the first operation mode in a case in which equipment equipped with the NFC tag having a dual mode normally operates, and performs the second operation mode in a case in which the equipment malfunctions. In this regard, the first operation mode may be related to an operation of the equipment equipped with the NFC tag having a dual mode, and the second operation mode may be an operation of transmitting a telephone number or a contact address or ID representing the telephone number or the contact address to an NFC reader.

The NFC tag having a dual mode, having been described with reference to FIGS. 1 and 2, may be embodied in a variety of apparatuses.

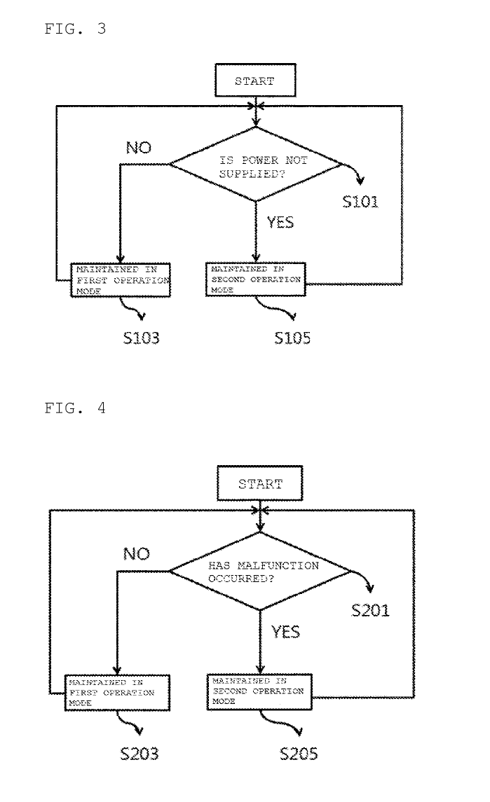

FIG. 3 is a diagram for explaining a method of operating an NFC tag having a dual mode, according to an embodiment of the present invention.

Referring to FIG. 3, a method of operating an NFC tag having a dual mode, according to an embodiment of the present invention may include: confirming whether or not power is supplied to the NFC tag having a dual mode (operation S101); maintaining a state (first operation mode) capable of performing a first operation (an operation of supporting a device equipped with the NFC tag) (operation S103); and maintaining a state capable of performing a second operation in a case in which power is not supplied to the NFC tag having a dual mode (operation S105). In this regard, the first operation refers to a normal operation, and the second operation is an operation of transmitting a telephone number or a contact address to a reader of the NFC tag.

FIG. 4 is a diagram for explaining a method of operating an NFC tag having a dual mode, according to another embodiment of the present invention.

Referring to FIG. 4, the method of operating an NFC tag having a dual mode, according to another embodiment of the present invention, may include: confirming whether or not malfunction occurs in equipment equipped with the NFC tag having a dual mode (operation S201); maintaining a state (a first operation mode) capable of performing a first operation (an operation of supporting the equipment equipped with the NFC tag) (operation S203); and maintaining a state capable of performing a second operation in a case in which malfunction occurs in the equipment equipped with the NFC tag having a dual mode (operation S205). In this regard, the first operation refers to a normal operation, and the second operation is an operation of transmitting a telephone number or a contact address to a reader of the NFC tag.

In addition, a method of operating an NFC tag having a dual mode according to an embodiment of the present invention may include: confirming whether or not power is supplied to the NFC tag or malfunction occurs in equipment equipped with the NFC tag having a dual mode; maintaining a state (a first operation mode) capable of performing a first operation (an operation of supporting the equipment equipped with the NFC tag); and maintaining a state capable of performing a second operation, in a case in which power is not supplied to the NFC tag having a dual mode or malfunction occurs in the equipment equipped with the NFC tag having a dual mode.

The above-described embodiments of the present invention are provided for illustrative purposes only, and it will be understood by those of ordinary skill in the art to which the present invention pertains that various changes and other equivalent embodiments may be made therefrom. Thus, it will be understood that embodiments mentioned in the detailed description are not intended to limit the scope of the present invention. Therefore, the true scope of the present invention should be defined by the spirit of the appended claims. In addition, it is to be understood that the present invention includes all modifications, equivalents, and substitutes within the spirit and scope of the present invention as defined by the appended claims.

1. An NFC tag having a dual mode, the NFC tag comprising:
a first NFC chip capable of performing a first operation; and
a second NFC chip capable of performing a second operation,
wherein the second NFC chip is in a state capable of performing the second operation in a case in which the NFC tag having a dual mode is unable to be supplied with power from the outside or malfunction occurs in equipment equipped with the NFC tag having a dual mode.

2. The NFC tag according to claim 1, wherein the second operation is an operation of transmitting a telephone number or a contact address to a reader of the NFC tag.

3. An NFC tag having a dual mode, the NFC tag comprising an NFC chip capable of performing a first operation or a second operation,
wherein the NFC chip is in a state capable of performing the second operation in a case in which the NFC tag having a dual mode is unable to be supplied with power from the outside or malfunction occurs in equipment equipped with the NFC tag having a dual mode.

4. The NFC tag according to claim 3, wherein the second operation is an operation of transmitting a telephone number or a contact address to a reader of the NFC tag.

5. A method of operating an NFC tag having a dual mode, the method comprising:
confirming whether or not power is supplied to the NFC tag having a dual mode or malfunction occurs in equipment equipped with the NFC tag having a dual mode;
maintaining a state of the NFC tag having a dual mode being supplied with power and capable of performing a normal operation; and
maintaining a state capable of performing a second operation in a case in which power is not supplied to the NFC tag having a dual mode or malfunction occurs in the equipment equipped with the NFC tag having a dual mode.

6. The method according to claim 5, wherein the second operation is an operation of transmitting a telephone number or a contact address to a reader of the NFC tag.
